(19) United States
(12) Patent Application Publication
(10) Pub. No.: US 2013/0317821 A1
(43) Pub. Date: Nov. 28, 2013

(54) SPARSE SIGNAL DETECTION WITH MISMATCHED MODELS

(71) Applicant: QUALCOMM INCORPORATED, San Diego, CA (US)

(72) Inventors: Shankar Sadasivam, San Diego, CA (US); Minho Jin, An-yang (KR); Leonard Henry Grokop, San Diego, CA (US); Edward Harrison Teague, San Diego, CA (US)

(73) Assignee: QUALCOMM INCORPORATED, San Diego, CA (US)

(21) Appl. No.: 13/733,026

(22) Filed: Jan. 2, 2013

Related U.S. Application Data
(60) Provisional application No. 61/651,383, filed on May 24, 2012.

(51) Int. Cl. G10L 25/78

(52) U.S. Cl. CPC G10L 25/78
USPC 704/236

(57) ABSTRACT

Various arrangements for detecting a type of sound, such as speech, are presented. A plurality of audio snippets may be sampled. A period of time may elapse between consecutive audio snippets. A hypothetical test may be performed using the sampled plurality of audio snippets. Such a hypothetical test may include weighting one or more hypothetical values greater than one or more other hypothetical values. Each hypothetical value may correspond to an audio snippet of the plurality of audio snippets. The hypothetical test may further include using at least the greater weighted one or more hypothetical values to determine whether at least one audio snippet of the plurality of audio snippets comprises the type of sound.

### CROSS-REFERENCE

This application claims priority from co-pending U.S. Provisional Patent Application No. 61/651,383, filed May 24, 2012, entitled “Sparse Signal Detection with Mismatched Models”, which is hereby incorporated by reference, as if set forth in full in this document, for all purposes.

### BACKGROUND

User experience with a wireless device, such as a cellular phone, may benefit from context awareness.

### SUMMARY

Various arrangements for detecting a type sound of sound in sparse samples is presented. In some embodiments, a method for detecting a type of sound is presented. The method may include sampling a plurality of audio snippets. The method may include performing a hypothetical test using the sampled plurality of audio snippets. The hypothetical test may include weighting one or more hypothetical values greater than one or more other hypothetical values, wherein each hypothetical value corresponds to an audio snippet of the plurality of audio snippets. The hypothetical test may include using at least the greater weighted one or more hypothetical values to determine whether at least one audio snippet of the plurality of audio snippets comprises the type of sound.

Embodiments of such a method may include one or more of the following: Sampling the plurality of audio snippets may include at least a period of time elapsing between consecutive audio snippets of the plurality of audio snippets during which audio is not sampled. The period of time elapsing between when consecutive audio snippets of the plurality of audio snippets are captured may be at least as long in time as one of the plurality of audio snippets. The type of sound may be speech. One or more audio snippets of the plurality of audio snippets may not contain the type of sound. Each audio snippet of the plurality of audio snippets may be equal to or less than 200 ms in length. The method may be performed by a mobile device that is not being used for a voice call. The method may include, in response to determining at least one audio snippet of the plurality of audio snippets comprises the type of sound, outputting an indication of the type of sound being present. The hypothetical test may include a modified log-likelihood ratio test being applied to the plurality of audio snippets.

Additionally or alternatively, embodiments of such a method may include one or more of the following: Using at least the greater weighted one or more hypothetical values to determine whether at least one audio snippet includes the type of sound may include comparing a summation of at least the greater weighted one or more hypothetical values to a predefined threshold value to determine whether at least one audio snippet includes the type of sound. Weighting the one or more hypothetical values greater than the one or more other hypothetical values may include maximizing the summation of at least the greater weighted one or more hypothetical values by setting a value of a weighting variable. Weighting the one or more hypothetical values greater than the one or more other hypothetical values may include setting a value of a weighting variable for each hypothetical value at least partially based on which hypothetical values are the greatest in magnitude. Performing the hypothetical test using the sampled plurality of audio snippets may include calculating a hypothetical value for each audio snippet of the plurality of audio snippets using a first probability model and a second probability model. The first probability model may indicate a first probability an audio snippet of the plurality of audio snippets includes the type of sound. The second probability model may indicate a second probability the audio snippet of the plurality of audio snippets does not include the type of sound.

In some embodiments, a computer program product residing on a non-transitory processor-readable medium for detecting a type of sound is presented. The computer program product may include computer-readable instructions configured to cause a computer system to sample a plurality of audio snippets. The computer-readable instructions may further be configured to cause the computer system to perform a hypothetical test using the sampled plurality of audio snippets. The hypothetical test may include weighting one or more hypothetical values greater than one or more other hypothetical values. Each hypothetical value may correspond to an audio snippet of the plurality of audio snippets. The hypothetical test may include using at least the greater weighted one or more hypothetical values to determine whether at least one audio snippet of the plurality of audio snippets comprises the type of sound.

Embodiments of such a computer program product may include one or more of the following: The computer-readable instructions configured to cause the computer system to sample the plurality of audio snippets further comprises additional computer-readable instructions may be further configured to cause the computer system to cause at least a period of time to elapse between consecutive audio snippets of the plurality of audio snippets during which audio is not sampled. The period of time elapsing between when consecutive audio snippets of the plurality of audio snippets are captured may be at least as long in time as one of the plurality of audio snippets. The type of sound may be speech. One or more audio snippets of the plurality of audio snippets may not contain the type of sound. Each audio snippet of the plurality of audio snippets may be equal to or less than 200 ms in length. The computer system may be a mobile device that is not being used for a voice call. The computer-readable instructions may further comprise additional computer-readable instructions configured to cause the computer system to output an indication of the type of sound being present in response to determining at least one audio snippet of the plurality of audio snippets comprises the type of sound. The hypothetical test may comprise a modified log-likelihood ratio test being applied to the plurality of audio snippets.

Additionally or alternatively, embodiments of such a computer program product may include one or more of the following: The computer-readable instructions configured to cause the computer system to use at least the greater weighted one or more hypothetical values to determine whether at least one audio snippet includes the type of sound further comprises additional computer-readable instructions configured to cause the computer system to compare a summation of at least the greater weighted one or more hypothetical values to a predefined threshold value to determine whether at least one audio snippet includes the type of sound. The computer-readable instructions configured to cause the computer system to weigh the one or more hypothetical values greater than the one or more other hypothetical values may further comprise additional computer-readable instructions configured to cause the computer system to maximize the summation of at least the greater weighted one or more hypothetical values by setting a value of a weighting variable. The computer-readable instructions configured to cause the computer system to weigh the one or more hypothetical values greater than the one or more other hypothetical values may further comprise additional computer-readable instructions configured to cause the computer system to set a value of a weighting variable for each hypothetical value at least partially based on which hypothetical values are the greatest in magnitude. The computer-readable instructions configured to cause the computer system to perform the hypothetical test using the sampled plurality of audio snippets may further include additional computer-readable instructions configured to cause the computer system to calculate a hypothetical value for each audio snippet of the plurality of audio snippets using a first probability model and a second probability model. The first probability model may indicate a first probability an audio snippet of the plurality of audio snippets includes the type of sound. The second probability model may indicate a second probability the audio snippet of the plurality of audio snippets does not include the type of sound.

In some embodiments, a mobile device is presented. The mobile device may include a microphone. The mobile device may include a processor. The mobile device may include a memory communicatively coupled with and readable by the processor and having stored therein processor-readable instructions. When executed by the processor, the instructions may cause the processor to sample a plurality of audio snippets from the microphone. The instructions may further cause the processor to perform a hypothetical test using the sampled plurality of audio snippets. The hypothetical test may include weighting one or more hypothetical values greater than one or more other hypothetical values, wherein each hypothetical value corresponds to an audio snippet of the plurality of audio snippets. The hypothetical test may further include using at least the greater weighted one or more hypothetical values to determine whether at least one audio snippet of the plurality of audio snippets comprises a type of sound.

Embodiments of such a mobile device may include one or more of the following: The processor-readable instructions configured to cause the processor to sample the plurality of audio snippets may comprise additional processor-readable that cause at least a period of time to elapse between consecutive audio snippets of the plurality of audio snippets during which audio is not sampled. The period of time elapsing between when consecutive audio snippets of the plurality of audio snippets are captured may be at least as long in time as one of the plurality of audio snippets. The type of sound may be speech. One or more audio snippets of the plurality of audio snippets may not contain the type of sound. Each audio snippet of the plurality of audio snippets may be equal to or less than 200 ms in length. The processor-readable instructions may not be performed during voice calls using the mobile device. The processor-readable instructions may further comprise additional processor-readable instructions configured to cause the processor to output an indication of the type of sound being present in response to determining at least one audio snippet of the plurality of audio snippets comprises the type of sound. The hypothetical test may comprise a modified log-likelihood ratio test being applied to the plurality of audio snippets. The processor-readable instructions configured to cause the processor to use at least the greater weighted one or more hypothetical values to determine whether at least one audio snippet may include the type of sound further comprises additional processor-readable instructions configured to cause the processor to compare a summation of at least the greater weighted one or more hypothetical values to a predefined threshold value to determine whether at least one audio snippet includes the type of sound.

Additionally or alternatively, embodiments of such a mobile device may include one or more of the following: The processor-readable instructions configured to cause the processor to weigh the one or more hypothetical values greater than the one or more other hypothetical values may further comprise additional processor-readable instructions configured to cause the processor to maximize the summation of at least the greater weighted one or more hypothetical values by setting a value of a weighting variable. The processor-readable instructions configured to cause the processor to weigh the one or more hypothetical values greater than the one or more other hypothetical values may further comprise additional processor-readable instructions configured to cause the processor to set a value of a weighting variable for each hypothetical value at least partially based on which hypothetical values are the greatest in magnitude. The processor-readable instructions configured to cause the processor to perform the hypothetical test using the sampled plurality of audio snippets may further comprise additional processor-readable instructions configured to cause the processor to calculate a hypothetical value for each audio snippet of the plurality of audio snippets using a first probability model and a second probability model. The first probability model may indicate a first probability an audio snippet of the plurality of audio snippets includes the type of sound. The second probability model may indicate a second probability the audio snippet of the plurality of audio snippets does not include the type of sound.

In some embodiments, an apparatus for detecting a type of sound is presented. The apparatus may include means for sampling a plurality of audio snippets. The apparatus may include means for performing a hypothetical test using the sampled plurality of audio snippets. The means for performing the hypothetical test may comprise means for weighting one or more hypothetical values greater than one or more other hypothetical values. Each hypothetical value may correspond to an audio snippet of the plurality of audio snippets. The means for using at least the greater weighted one or more hypothetical values to determine whether at least one audio snippet of the plurality of audio snippets comprises the type of sound.

Embodiments of such an apparatus may include one or more of the following: The means for sampling the plurality of audio snippets may be configured such that at least a period of time elapses between consecutive audio snippets of the plurality of audio snippets during which audio is not sampled. The period of time elapsing between when consecutive audio snippets of the plurality of audio snippets are captured may be at least as long in time as one of the plurality of audio snippets. The type of sound may be speech. One or more audio snippets of the plurality of audio snippets may not contain the type of sound. Each audio snippet of the plurality of audio snippets may be equal to or less than 200 ms in length. The apparatus may be part of a mobile device. The apparatus may include means for outputting an indication of the type of sound being present in response to determining at least one audio snippet of the plurality of audio snippets comprises the type of sound. The hypothetical test may comprise a modified log-likelihood ratio test being applied to the plurality of audio snippets. The means for using at least the greater weighted one or more hypothetical values to determine whether at least one audio snippet includes the type of sound may include means for comparing a summation of at least the greater weighted one or more hypothetical values to a predefined threshold value to determine whether at least one audio snippet includes the type of sound.

Additionally or alternatively, embodiments of such an apparatus may include one or more of the following: The means for weighting the one or more hypothetical values greater than the one or more other hypothetical values may include means for maximizing the summation of at least the greater weighted one or more hypothetical values by setting a value of a weighting variable. The means for weighting the one or more hypothetical values greater than the one or more other hypothetical values may include means for setting a value of a weighting variable for each hypothetical value at least partially based on which hypothetical values are the greatest in magnitude. The means for performing the hypothetical test using the sampled plurality of audio snippets may include means for calculating a hypothetical value for each audio snippet of the plurality of audio snippets using a first probability model and a second probability model. The first probability model may indicate a first probability an audio snippet of the plurality of audio snippets includes the type of sound. The second probability model may indicate a second probability the audio snippet of the plurality of audio snippets does not include the type of sound.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system configured to determine whether a type of sound is present in one or more sampled audio snippets.

FIG. 2 illustrates an embodiment of a visualization of the sampling of an audio stream.

FIG. 3 illustrates an embodiment of a method for determining whether a type of sound is present in one or more audio snippets.

FIG. 4 illustrates an embodiment of a method for determining whether speech is present in one or more audio snippets using a modified likelihood ratio test.

FIG. 5 illustrates an embodiment of a graph of speech detection using audio snippets and the standard likelihood ratio test.

FIG. 6 illustrates an embodiment of a graph of speech detection using audio snippets and a modified likelihood ratio test.

FIG. 7 illustrates an embodiment of a computer system.

### DETAILED DESCRIPTION

Context awareness may refer to the ability of the mobile device to determine characteristics of its surrounding environment. For example, it may be beneficial for a mobile device to determine if it is in a loud environment or a quiet environment. Such information may, for example, be used to determine whether a ringer of the wireless device should be enabled or disabled and, if enabled, how loud the ringer of the wireless device should be set.

While context awareness may be useful for controlling the functionality of a mobile device, such as a cellular phone, several aspects of the processing required to perform a context awareness may benefit from improvement. Since context awareness may be performed by a mobile device, power consumption by the mobile device while performing a context awareness may deplete a power source, such as a battery, of the mobile device. Also, privacy concerns of the user of the mobile device may negatively bias the user from desiring context awareness. As an example, some forms of context awareness may be based on audio present in the environment of the mobile device performing the context awareness analysis. In order for the mobile device to be aware of the audio present within the mobile device's environment, the mobile device may need to capture and at least temporarily store a recording of the audio. Such recording of the mobile device's audio environment may alarm users and other persons in the vicinity of the mobile device that audio, such as their conversations, are being recorded and used to unknown ends.

For reasons such as to assuage privacy concerns and/or reduce power consumption, it may be useful for a mobile device to perform an auditory context awareness analysis without storing a continuous captured audio stream. Rather, brief “snippets” of audio may be captured by the mobile device that are sufficient to allow for an auditory context awareness analysis to be conducted. Since the snippets of audio are brief and may be spaced out in time, even if stored, the audio snippets may be difficult or impossible to use to reconstruct audio in a way that would concern users, such as to determine what is being said in a conversation in the vicinity of a mobile device performing an auditory context awareness analysis. The mobile device (which may be a cellular phone) may record the audio snippets when the mobile device is not being used for a voice call. As such, the user of the mobile device and persons in the vicinity of the mobile device may not be expecting or desirous of the mobile device recording a conversation, regardless of whether the audio snippets are only stored temporarily and/or are not transmitted across a network. Further, by using only brief snippets of audio, the amount of power consumed by the mobile device in conducting the auditory context awareness analysis may be decreased. Since over a given period of time where snippets of audio are captured and stored, less audio is captured and stored than if a continuous stream of audio was captured by the mobile device. Accordingly, less audio is captured, stored, and processed by the mobile device.

While capturing only snippets of audio to perform an auditory context awareness analysis may be useful for privacy, power consumption, and/or other performance aspects of the mobile device, using such snippets may make a successful detection of the auditory environment more difficult. For example, it may be useful to determine whether speech is present in the vicinity of the mobile device. However, since multiple snippets of audio are being used to determine the mobile device's auditory environment, some of these snippets may contain speech while others may not because the speech may have ended or temporarily halted. As such, a sparse truth may need to be determined “Sparse truth” refers to a condition being present in at least one, but possibly not all, of the sampled audio snippets. Referring to the example of speech, the sparse truth may be whether speech is present in at least some of the audio snippets. For the sparse truth to be true, only some of the audio snippets may need to include speech.

Further, when using such audio snippets for an auditory context awareness analysis, it may not be known how much noise is present in the environment and/or the noise level may vary from one captured audio snippet to the next. As such, when analyzing the audio snippets, mismatched models may be present due to the collected audio snippets having an unknown amount of noise. Accordingly, a probabilistic analysis of whether an audio sample contains a type of sound, such as speech, may use one or more models for analysis that are based on different signal-to-noise ratios (SNR) than the captured audio snippets. To possibly further complicate the analysis, individual captured audio snippets may have different SNRs from other captured audio snippets.

The embodiments detailed herein may be applied to detecting the presence of various types of sound in the environment of a mobile device. One particular type of sound that may be useful in detecting is speech. Determining whether speech (which is defined to include all sound made by a person's voice) is present in the environment of a device may be a useful form of context awareness. Such speech detection may be referred to as voice activity detection (VAD). Various functions of the mobile device may be modified, performed, or not performed in response to speech being present or speech not being present in the environment of the device. As a simple example, if speech is present in the environment of a mobile device, the mobile device may not ring to signal an incoming call; rather, a vibration function may be used. The performance of various other functions may be modified or otherwise altered in response to the presence of speech in the environment of the mobile device. Besides speech, types of sound may include: engine sounds, a baby crying, an alarm, one or more tones, music, specific from a specific person (e.g., user of the mobile device), typing, street noise, etc. The following description focuses on the type of sound being speech, however it should be understood that the embodiments may be adapted to detecting the presence of other types of sound.

In order to detect the presence of human speech, multiple short audio samples referred to as audio snippets may be captured by the mobile device and analyzed. Such short audio samples may be referred to as audio snippets. Such audio snippets may be short in duration, and amounts of time may elapse between the recording of consecutive audio snippets. As an example, a 150 ms audio snippet may be captured once every 6 seconds by a mobile device. Such audio snippets may be used to make a determination as to whether speech is present in at least some of the audio samples once every 4 minutes, for example. It should be understood that the duration of the audio snippets, the frequency of when the audio snippets are captured, and how often the audio snippets are used to determine if speech is present may vary in other embodiments.

Captured audio snippets may be used in conjunction with a modified likelihood ratio test to determine if speech is present in some (e.g., one or more, or some percentage) of the captured audio snippets. In a modified likelihood ratio test, logarithmic likelihood ratios may be weighted based on which logarithmic likelihood ratios are more likely to indicate the presence of speech (e.g., have a greater magnitude). Logarithmic likelihood ratios that indicate the presence of speech may be weighted more than logarithmic likelihood ratios that do not indicate the presence of speech. The weighting may involve either: using (by using a weighting factor of 1) or not using (by using a weighting factor of zero) a logarithmic likelihood ratio. Therefore, for example, out of a set of captured audio snippets, only some of these audio snippets (e.g., those most likely to contain speech) may be used in determining if speech is present in the environment of the mobile device.

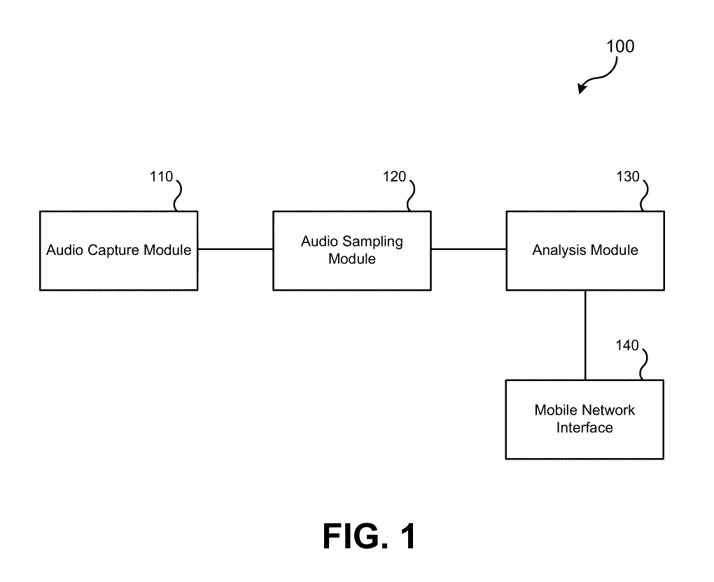

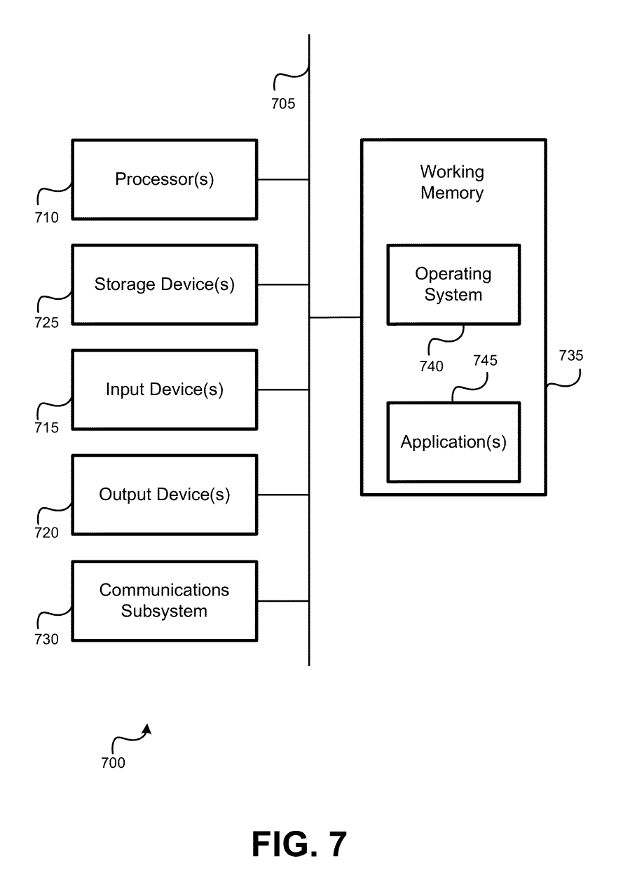

FIG. 1 illustrates an embodiment of a system 100 configured to determine whether speech is present in audio snippets. System 100 may include: audio capture module 110, audio sampling module 120, analysis module 130, and/or mobile network interface 140. System 100 may include or be a part of a computer system, such as computer system 700 in FIG. 7. System 100 may be incorporated as part of a mobile device, such as a cellular phone, tablet computer, vehicle-based entertainment/navigation system, laptop, or some other form of portable computerized device. Further, embodiments of system 100 may be incorporated into non-mobile devices, such as desktop computer systems, servers, etc. Accordingly, while the description of embodiments herein are focused on the analysis of audio snippets by a mobile device, it should be understood that the embodiments may be applied to non-mobile devices.

Audio capture module 110 may be used to capture audio snippets. Audio capture module 110 may include one or more microphones. On a mobile device, the microphone used may be the same microphone used by a user for a voice call and/or may include one or more separate microphones. Audio capture module 110 may be activated periodically to capture the audio snippets. When an audio snippet is not being captured, audio capture module 110 may be disabled. In some embodiments, audio capture module 110 captures a continuous stream of audio, however portions of the captured audio are ignored by audio sampling module 120 and are not stored.

Audio sampling module 120 may control the activation of audio capture module 110 and/or sample (e.g., record) audio snippets. In some embodiments, audio capture module 110 is continually capturing audio and outputting an audio stream, while audio sampling module 120 only periodically samples audio snippets from the audio stream output by audio capture module 110. The functions of audio sampling module 120 may be performed by a processor. The audio snippets sampled by audio sampling module 120 may be at least temporarily stored by a computer-readable storage medium, such as random access memory.

Analysis module 130 may perform a modified logarithmic (log) likelihood test and output an indication of whether or not speech has been detected in one or more of the audio snippets that has been sampled by audio sampling module 120. The functions of analysis module 130 may be performed by a processor, such as the same processor that may perform the functions of audio sampling module 120. Separate processors may also be used for audio sampling module 120 and analysis module 130. In some embodiments, rather than analysis module 130 being physically located within a mobile device, analysis module 130 may be located remotely from the mobile device accessible via a wireless network. In such embodiments, audio snippets may be transmitted to the analysis module 130 (such as via a mobile network). In such embodiments, a determination by analysis module 130 as to whether speech is present in one or more of the audio snippets may be returned to the mobile device and/or may be used by some other system located remotely from the mobile device.

Mobile network interface 140 may permit communication with a wireless network, such as a cellular network. If analysis module 130 is located remotely from a mobile device, mobile network interface 140 may be used to transmit audio snippets to analysis module 130. If analysis module 130 is located at a mobile device, mobile network interface 140 may be used to transmit an indication of whether or not speech is present within the one or more of the audio snippets. In such embodiments, mobile network interface 140 may not be used to transmit audio snippets to a mobile network.

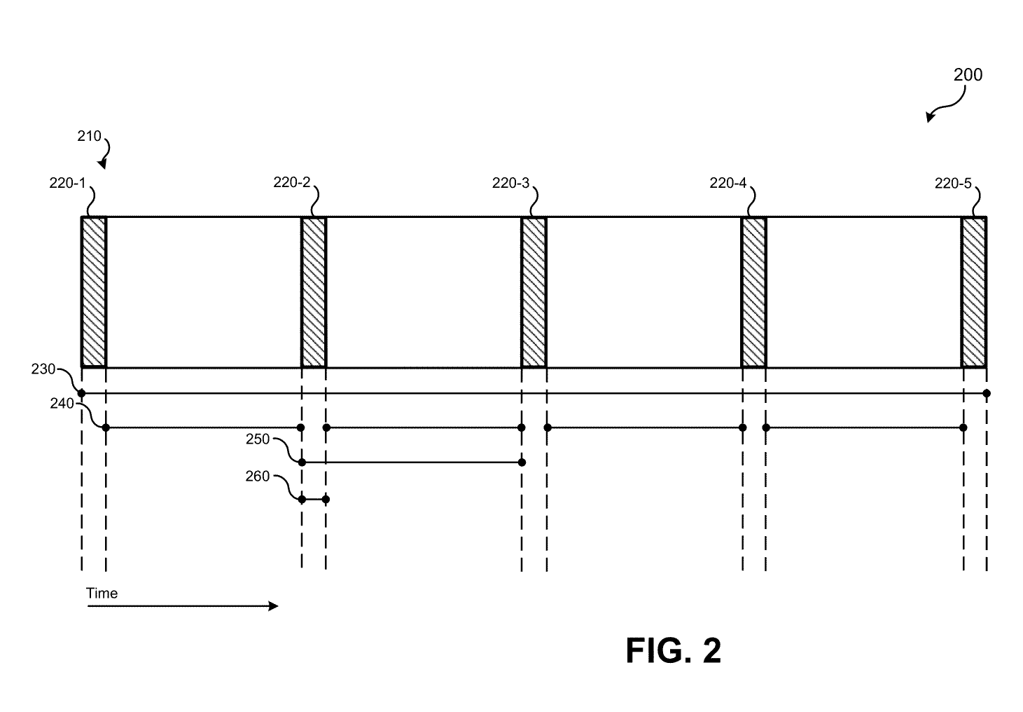

FIG. 2 illustrates an embodiment of a visualization 200 of the sampling of an audio stream. Visualization 200 is not illustrated to scale. Audio stream 210 may represent a stream of audio being captured. Referring to FIG. 1, audio stream 210 may be captured by audio capture module 110. Audio stream 210 may represent an audio stream captured by a mobile device such as a cellular phone. Snippets from the audio stream 210 may be captured in order to determine if human speech is or is not present in the vicinity of the mobile device. While audio stream 210 may continuously be present in the environment of the mobile device, only a portion of audio stream 210 is illustrated. After an amount of time 230 has elapsed, a decision as to whether speech is present may be made. For example, time 230 may be four minutes. Accordingly, in such embodiments, a determination as to whether speech is present may be made once every four minutes. The determination of whether speech is present may be based on the audio snippets captured during the preceding four minutes. Besides 4 minutes, time 230 may be 1 minute, 2 minutes, 3 minutes, 5 minutes, or some greater length of time. A typical range may be somewhere between 1 and 4 minutes.

While audio stream 210 may represent an audio stream that is continuously present in the environment of the mobile device, audio snippets may be captured and stored for discrete periods of time. In visualization 200, four audio snippets 220 are sampled and stored. Referring to system 100 of FIG. 1, audio sampling module 120 may capture and store audio snippets 220. Each audio snippet of audio snippets 220 may be short in duration of time. Each audio snippet of audio snippets 220 may be made sure enough in time, with enough time lapsing between the capture of consecutive audio snippets, to ensure that it would be difficult or impossible to determine the content of human speech occurring in the environment of the mobile device. Time 260, which represents the duration of each audio snippet of audio snippets 220, may be 150 ms in length. Time 260 may be other lengths of time, such as 100 ms, 200 ms, 300 ms, 75 ms. A typical range for audio snippets may be between 30 ms and 150 ms. Time 260 represents the duration of audio snippet 220-2. The duration of other audio snippets of audio snippets 220 may be the same duration or of a different time duration.

Between the capture of consecutive audio snippets, a period of time may elapse when audio is not captured and stored. Such gaps of time between the capture of audio may serve to preserve privacy of persons in the environment of the mobile device and/or reduce power consumption by reducing the amount of audio that is recorded and stored. Referring to visualization 200, time 240 represents the periods of time when audio is not being captured and stored as audio snippets. The time between consecutive audio snippets being captured may be greater in duration than individual audio snippets. As such, less than 50% of the audio present in audio stream 210 may be captured as audio snippets 220. In some embodiments, much less than 10% of the audio present in audio stream 210 may be captured as audio snippets 220, such as less than 10%, less than 5%, or less than 1%. Any percentage between 0% and 100% may be possible. If a 150 ms audio snippet is captured once every 6 seconds, 2.5% of audio stream 210 may be captured and stored.

Time 250 represents the sampling period of audio snippets 220. In some embodiments, time 250 may be 6 seconds. In other embodiments, time 250 may be 1, 2, 3, 4, 5, 7, 8, 9 or more seconds. In some embodiments, time 250 may range from 500 ms to 6 s. The greater time 250 is, the less power and/or the greater the expectation of privacy may be due to the length of time between audio snippets being captured.

As an exemplary embodiment, time 230 may be 4 minutes. As such, after 4 minutes, a decision as to whether speech is present in a threshold number of audio snippets may be made. In this embodiment, time 250 may be 6 seconds and time 260 may be 150 ms. Accordingly, in such embodiments, time 240 may be 5.85 seconds. Following 4 minutes a lapsing and a decision being made as to whether human speech is present based on the audio snippets captured and stored in the previous four minutes, a new four minute period of time may commence with another decision being made at the conclusion of the four minutes. While this embodiment involves the duration of the audio snippets, frequency of the audio snippets remaining constant, and decision frequency remaining constant, it should be understood that in other embodiments, one or more of these timing values may vary.

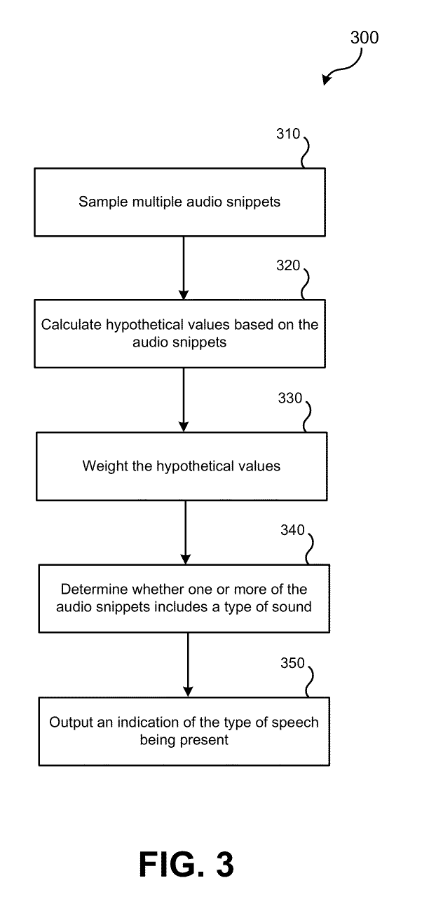

System 100 may be used to perform various methods involving sampling and analyzing audio snippets for the presence of a type of sound, such as speech. FIG. 3 illustrates a method 300 for determining whether speech is present in one or more audio snippets. Method 300 may be performed using system 100 of FIG. 1 or some other system configured to determine whether speech is present in one or more audio snippets. Method 300 may be performed periodically, such as once every 4 minutes. A computerized device, such as a computer system, may be used to perform at least some of the steps of method 300. Means for performing the steps of method 300 include mobile devices, computer systems, audio capture modules (which may include one or more microphones), an audio sampling module (which may include one or more processors), an analysis module (which may include one or more processors), one or more computer-readable storage mediums, and, more generally, computerized devices. If performed by a mobile device, method 300 may be performed when the mobile device is not being used for a voice call.

At step 310, multiple audio snippets may be sampled. Such audio snippets may be short in duration, such as less than 300 ms (e.g., 150 ms) in length. Time may elapse between the sampling of consecutive audio snippets, such that no audio is stored during such time periods. The sampling of audio snippets may be performed in accordance with visualization 200 of FIG. 2. For example, multiple seconds (e.g., 6 s) may elapse between each consecutive audio snippet being captured. Due to the short duration of each audio snippet and the length of time that elapses between audio snippets being sampled, privacy of a user may be protected because only a small percentage of the audio over a given period of time is recorded. For example, substantive content of a conversation may not be determined using such audio snippets. Since the audio snippets are recorded over an extended period of time, such as four minutes (with a single snippet being captured once every six seconds, for example), some audio snippets may contain speech while others do not contain speech.

At step 320, hypothetical values may be calculated based on the audio snippets. For each audio snippet, a hypothetical value may be calculated. Each hypothetical value may be indicative of whether a particular audio snippet is drawn from various probability distributions. More specifically, a hypothetical value may be calculated based on whether an audio snippet is drawn from a first or second probability distribution. When the audio snippet is evaluated for each probability distribution, the greater the resulting value, the more likely the audio snippet is drawn from the probability distribution. For determining whether a type of sound is present, one of the probability distributions may be drawn to the presence of the sound, and the second probability distribution may be drawn to the absence of the sound. The hypothetical value may be calculated based on a mathematical function being performed using both the result of the audio snippet being applied to the first probability distribution and the second probability description. For example, the result of the first probability distribution may be divided by the result of the second probability distribution to determine the hypothetical value.

At step 330, a modified likelihood ratio test may be performed to determine if the type of sound is likely present within at least some (e.g., one or more) of the audio snippets sampled at step 310. The modified likelihood ratio test may perform a likelihood ratio test with hypothetical values based on some audio snippets being afforded a greater weight than hypothetical values based on other audio snippets. Log-likelihood ratio tests may tend to be more accurate in determining audio snippets that contain the type of sound than in determining audio snippets that do not contain the type of sound. Therefore, hypothetical values based on audio snippets that are indicative of the presence of the type of sound may be given greater weight than hypothetical values based on other audio snippets that are not indicative of the presence of speech.

In some embodiments, weighting likelihood ratios may involve using only certain hypothetical values based on audio snippets that are most likely to indicate the presence of speech being used. Hypothetical values based on audio snippets that are less likely to indicate the presence of speech may be ignored or discarded. In other embodiments, weighting may involve assigning weights to such calculations. For example, a first calculation based on an audio snippet that is most likely to indicate the presence of speech (of the audio snippets considered) may be given a greatest weight. A second calculation based on an audio snippet that is most likely (besides the first calculation) to indicate the presence of speech may be given a weight less than the greatest weight, but more than the weight of calculations based on other audio snippets that are less likely to contain speech.

In some embodiments, it should be understood that hypothetical values that are based on other than a log-likelihood ratio test may be used. For instance, different types of hypothetical values may be weighted.

At step 340, a determination may be made as to whether one or more of the audio snippets on which the modified likelihood ratio test was performed at step 330 is likely to contain the type of sound, such as speech. This may involve comparing a value using the weighted hypothetical value to a predefined threshold value. The threshold value may be based on the number of false alarms willing to be tolerated. That is, the higher the threshold is set, the fewer the number of false alarms (indications of the type of sound being present, when, in fact, the type of sound is not present) may be reported. However, by increasing the threshold, the number of instances where the type of sound is not identified, when there was, in fact, the type of sound in at least one of the audio snippets, may increase. As such, a balance may need to be found between an acceptable number of false alarms and missed instances of speech being present in the audio snippets for a threshold value.

At step 350, an indication of whether or not the type of sound was determined to be present in one or more of the audio snippets sampled at step 310 may be output. Such an output may remain local to a device (e.g., a mobile device), or may be output to a remote device, such as a host computer system, via a mobile network. Functionality of the mobile device may be affected by the determination that the audio snippets were determined to contain or not contain the type of sound.

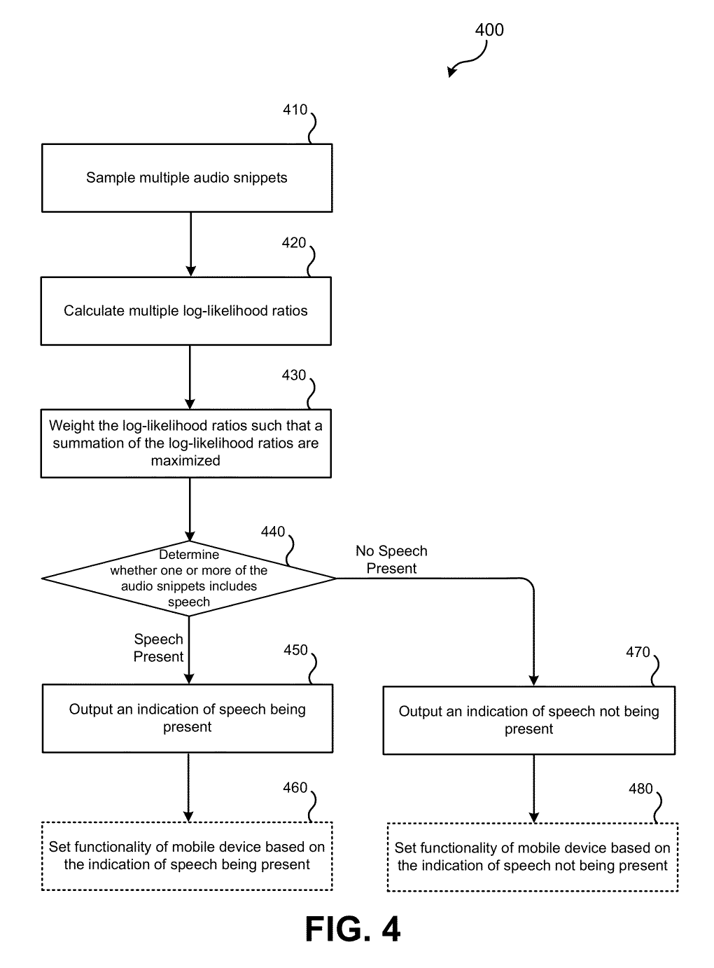

FIG. 4 illustrates an embodiment of a method 400 for determining whether speech is present in one or more audio snippets. Method 400 may represent a more detailed embodiment of method 300 of FIG. 3. Method 400 may be performed periodically, such as once every 4 minutes. Method 400 may be performed using system 100 of FIG. 1 or some other system configured to determine whether speech is present in one or more audio snippets. If method 400 is performed by a mobile device, such as a cellular phone, method 400 may be performed at a time when the mobile device is not being used for a voice call. A computerized device, such as a computer system, may be used to perform method 400. Means for performing the steps of method 400 include mobile devices, computer systems, audio capture modules (which may include one or more microphones), an audio sampling module (which may include one or more processors), an analysis module (which may include one or more processors), one or more computer-readable storage mediums, and, more generally, computerized devices. If a mobile device is used in performing method 400, some steps may be performed by the mobile device, while other steps may be performed remotely from the mobile device by a computer system in wireless communication with the mobile device.

At step 410, multiple audio snippets may be sampled. Such audio snippets may be short in duration, such as less than 200 ms (e.g., 150 ms) in length or a duration in time as discussed in relation to visualization 200 of FIG. 2. Time may elapse between the sampling of consecutive audio snippets. During this time, audio samples may not be captured and/or stored. For example, multiple seconds (e.g., 6 s) may elapse between each consecutive audio snippet being captured. As such, due to the short duration of each audio snippet and the length of time that elapses between sampling of audio snippets, privacy may be protected because only a small percentage of audio over a given period of time is recorded and/or an amount of power used in capturing and analyzing the audio may be decreased. The length of such audio snippets and time between the audio snippets being sampled may vary by embodiment. Since the audio snippets are recorded over an extended period of time, such as four minutes (with a single snippet being captured each six seconds, for example), some audio snippets may contain speech while others do not contain speech. As such, a sparse truth may be determined using method 400. If the type of sound attempted to be detected is speech, then the sparse truth may be speech being present in at least one, but possibly not all, of the audio snippets.

Equation 1 represents an embodiment of a modified likelihood ratio test. At step 420, multiple log-likelihood ratios may be calculated using the multiple audio snippets sampled at step 410. For each audio snippet, a log-likelihood ratio may be calculated. A log-likelihood ratio may be calculated for each audio snippet sampled at step 410.

$$( {max}_{π} {\sum }_{i = 1}^{N} {π}_{i} log \frac{{P}_{1} ( {y}_{i} )}{{P}_{0} ( {y}_{i} )} ) > τ \qquad Eq . 1$$

Each audio snippet sampled at step 410 may be used to create separate observations yᵢ. Equation 2 represents the log-likelihood ratio portion of equation 1. This log-likelihood ratio that is calculated may be considered a hypothetical value, such as discussed in relation to method 300.

$$log \frac{{P}_{1} ( {y}_{i} )}{{P}_{0} ( {y}_{i} )} \qquad Eq . 2$$

Equation 1 may be used to test two hypotheses: (1) H₁, wherein at least one observation (yᵢ, i=1 to N) is drawn from P₁; and (2) H₂, none of the observations (yᵢ, i=1 to N) is drawn from P₁ (that is, all are drawn from P₀). P₁ and P₀ represent probability distributions. In H₁, one or more audio snippets (yᵢ) contains speech (in other embodiments, some other type of sound may be used); in H₀, no audio snippets contain speech. P₁(yᵢ) is the probability that yᵢ is drawn from probability distribution P₁; P₀(yᵢ) is the probability that yᵢ is drawn from probability distribution P₀. P₁ is the probability distribution for speech. The P₁ distribution may be for clean speech, that is, speech with very low or no noise. The signal to noise ratio (SNR) of yᵢ may be unknown. P₀ is the probability distribution for the absence of speech. The log-likelihood ratio of equation 2, which is a portion of the modified log-likelihood ratio test of equation 1, is computed for the audio snippets sampled at step 410.

Inaccuracies in determining a type of sound, such as speech, being present in an audio snippet using a probability model may occur due to model mismatch. This model mismatch may refer to the fact that H₁ and its associated probability distribution P₁ may not accurately reflect the statistical model for the SNR of the audio snippets being sampled. The probability distribution P₁ may be based on a model (e.g., for speech, a speech model) that is trained using previously collected speech samples. As such, a probability distribution (P₁) modeled on speech samples at first SNR (e.g., no noise or little noise) may be used for detecting speech in audio snippets of a second, different SNR. For instance, the second SNR may be different due to additive noise, reverberation, channel mismatch, etc. being present in the audio snippets which were not present in the audio used to train the speech model used to create probability distribution P₁. As such the SNR of the speech model used to create P₁ can be expected to be different than the SNR of the audio snippets. Further, the SNR among the audio snippets used in method 400 may vary. In the embodiments discussed herein, such model mismatch may be present between the audio snippets and the audio model used to create P₁ among audio snippets.

At step 430, the various log-likelihood ratios may be weighted. This weighting may involve one or more of the log-likelihood ratios calculated at step 420 being weighted greater than one or more of the other log-likelihood ratios calculated at step 420. The accuracy of log-likelihood ratios tends to be greater (e.g., maximized) for audio snippets that are likely to contain speech. Since the purpose of method 400 is to determine the presence or absence of speech in one or more of the audio snippets, the calculated hypothetical values based on audio snippets that are indicative of speech being present may be afforded a greater weight than calculated hypothetical values based on audio snippets that that are indicative of speech not being present.

In equation 1, the weight given to hypothetical values (the calculated log-likelihood ratios) is represented by π₁, which may be referred to as a weighting variable. In some embodiments, π₁ may be restricted to being either one or zero. Therefore, weighting log-likelihood ratios may involve either retaining a log-likelihood ratio (by multiplying it by one) or discarding the log-likelihood ratio (by multiplying it by zero). In other embodiments, m₁ may be within a range of values, such as between zero and one, inclusive. Equation three may be used to determine the values which m₁ may be.

(Σᵢ₌₁^{N}πᵢ)<fN Eq. 3

In equation three, f may be from zero to one. N may represent the number of audio snippets captured and used for the analysis, and thus may also represent the number of hypothetical values calculated. f may be predetermined and set. f may be set based on the sparsity level of speech in the audio snippets desired to be detected. For instance, if the minimum desired sparsity level of speech is 20% of the audio snippets (that is, speech is present in as few as 20% of the audio snippets), the value off may be set to a lower threshold, such as 0.1. Therefore, according to equation three, a summation of all of the values of π₁ used is less than the value off multiplied by the number of audio snippets. The value off may be set so that a single audio snippet that includes speech will be detected. As previously discussed, π₁ may be restricted to being either one or zero. Other values of π₁ may also be possible that satisfy equation three.

The value of π₁, in accordance with equation three, may be selected to maximize the summation of equation one. This maximization is represented by max_{π}. Various known processes for maximizing an output of an equation by varying a variable may be used to determine the maximum value of equation one when π₁ is varied in accordance with equation four.

As a simple example, if there are 100 samples (N=100) and f is set to 0.1 (that is, speech is desired to be detected in a minimum of 10% of the captured samples, in this example 10 samples) and π₁ is permitted to be only 1 or 0, the summation of π₁ of equation three may be 9. Thus nine log-likelihood ratios of equation one may be used for calculating the maximum value of the summation of equation one (with the rest of the log-likelihood ratios multiplied by zero). The nine log-likelihood ratios retained (that is, the nine log-likelihood ratios multiplied by a π₁ value of 1) may be the log-likelihood values (the hypothetical values) greatest in magnitude. Since P₁ represents the probability that yᵢ is part of the probability distribution that indicates speech, the P₁ log-likelihood values greatest in magnitude are those that are most likely to contain speech. Further, since P₀ represents the probability that yᵢ is part of the probability distribution that does not contain speech, the P₀ log-likelihood values greatest in magnitude are those that are most likely to not contain speech. Since P₁ is divided by P₀, the more likely speech is determined to be present, the greater the magnitude of the log-likelihood ratio will be. Accordingly, in this example, the nine “top-bracket” or log-likelihood values greatest in value are used in the summation of equation 1.

Following step 430, the calculated value of the summation, when maximized for πᵢ, may be compared to a predefined value τ. This comparison may be performed at step 440 to determine whether one or more of the audio snippets is determined to contain speech. If the maximized summation exceeds τ, it may be determined that speech is present in at least the number of audio snippets greater than the percentage of audio snippets defined by f If the maximized summation does not exceed τ, it may be determined that speech is not present in at least the number of audio snippets greater than the percentage of audio snippets defined by f.

Step 450 may be performed if at step 440 speech was determined to be present in one or more audio snippets (or at least the percentage of audio snippets defined by f). At step 450, an indication of speech being identified as present in one or more of the audio snippets sampled (that is, H₁ being true) may be output. Such an output may remain local to the device (e.g., a mobile device) performing method 400, or may be output to a remote device, such as a host computer system of a mobile network or a mobile device if the determination occurred remote from the device performing method 400. Functionality of the device may be adjusted at least partially based on the determination that the audio snippets were determined to contain speech.

At step 460, based upon the output of step 450, the functionality of the device may be set. For instance, the setting of the ringer of the mobile device may be adjusted in response to speech being present in the environment of the mobile device.

Step 470 may be performed if at step 440 speech was determined to not be present in one or more audio snippets (or at least the percentage of audio snippets defined by f). At step 470, an indication of speech not being identified as present in one or more of the audio snippets sampled (that is, H₀ being true) may be output. Such an output may remain local to the device (e.g., a mobile device) performing method 400, or may be output to a remote device, such as a host computer system of a mobile network or a mobile device if the determination occurred remote from the mobile device. Functionality of the device performing method 400 may be adjusted at least partially based on the determination that the audio snippets were determined to not contain speech.

At step 480, based upon the output of step 470, the functionality of the device may be set. For instance, the setting of the ringer of the mobile device may be adjusted in response to speech not being present in the environment of the mobile device.

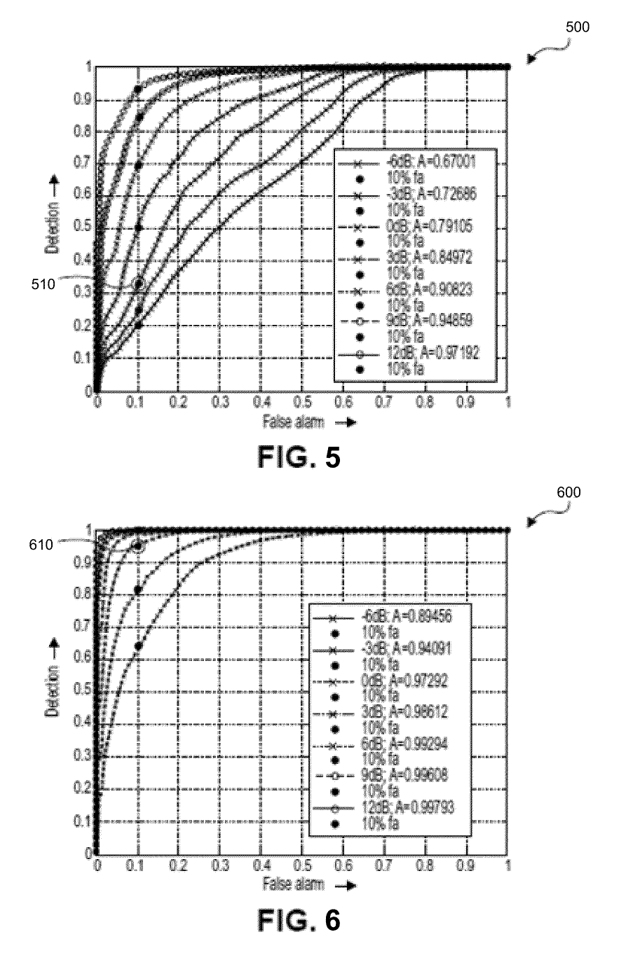

FIGS. 5 and 6 illustrate embodiments of graphs. FIG. 5 illustrates an embodiment of a graph 500 of speech detection using audio snippets and a standard likelihood ratio test. FIG. 6illustrates an embodiment of a graph 600 of speech detection using audio snippets and a modified likelihood ratio test, such as that used in conjunction with method 400. Each graph represents the false alarm rate (the percentage of times speech was identified as present in one or more audio snippets when, in fact, no speech was present) on the x-axis and the detection rate (the percentage of times speech was identified as present in one or more audio snippets when, in fact, speech was present) on the y-axis. Each line on the graphs represents performance at a different signal to noise ratio (SNR). In both graphs 500 and 600, the sparsity is 20% (speech is present in only 20% of the audio snippets sampled).

When performing method 300 or method 400, it may be expected that the SNR of audio snippets will vary significantly. For example, if a microphone of a mobile device is being used to at least capture the audio samples, there is a possibility that the mobile device may be in the user's pocket, may be located in different positions in relation to persons talking, etc. In both FIGS. 5 and 6, points (point 510 and point 610, respectively) on lines associated with 0 dB SNR are selected. Each of these points correspond to a false alarm rate of 10% (0.1), as indicated on the x-axis. For the embodiments of the modified log-likelihood test used to produce graph 600 of FIG. 6, the detection rate when the modified log-likelihood ratio test is applied is significantly improved compared to a standard log-likelihood ratio test. In graph 500 of FIG. 5, a detection rate of approximately 33% is present at point 510. In graph 600 of FIG. 6, however, a detection rate of approximately 96% is present at point 610. As such, in at least the embodiments associated with the illustrated graphs, a modified log-likelihood ratio test is significantly improved at detecting the presence of speech in a sparse truth situation of 20% than a standard log-likelihood test. At other SNR levels, represented by other lines in graphs 500 and 600, a similar increase in detection rate at the same false alarm rate may be found.

A computer system as illustrated in FIG. 7 may be incorporated as part of the previously described computerized devices. For example, computer system 700 can represent some of the components of the mobile devices and/or the remote computer systems (e.g., a host computer system in communication with a mobile device via a wireless network) discussed in this application. Computer system 700 may perform the functions of some or all of the modules of system 100 of FIG. 1, such as the analysis module and the sampling module. FIG. 7 provides a schematic illustration of one embodiment of a computer system 700 that can perform the methods as described herein. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for detecting a type of sound, the method comprising:
sampling a plurality of audio snippets;
performing a hypothetical test using the sampled plurality of audio snippets, the hypothetical test comprising:
weighting one or more hypothetical values greater than one or more other hypothetical values, wherein each hypothetical value corresponds to an audio snippet of the plurality of audio snippets; and
using at least the greater weighted one or more hypothetical values to determine whether at least one audio snippet of the plurality of audio snippets comprises the type of sound.

2. The method for detecting the type of sound of claim 1, wherein sampling the plurality of audio snippets comprises at least a period of time elapsing between consecutive audio snippets of the plurality of audio snippets during which audio is not sampled.

3. The method for detecting the type of sound of claim 2, wherein the period of time elapsing between when consecutive audio snippets of the plurality of audio snippets are captured is at least as long in time as one of the plurality of audio snippets.

4. The method for detecting the type of sound of claim 1, wherein the type of sound is speech.

5. The method for detecting the type of sound of claim 1, wherein one or more audio snippets of the plurality of audio snippets do not contain the type of sound.

6. The method for detecting the type of sound of claim 1, wherein each audio snippet of the plurality of audio snippets is equal to or less than 200 ms in length.

7. The method for detecting the type of sound of claim 1, wherein the method is performed by a mobile device that is not being used for a voice call.

8. The method for detecting the type of sound of claim 1, further comprising:
in response to determining at least one audio snippet of the plurality of audio snippets comprises the type of sound, outputting an indication of the type of sound being present.

9. The method for detecting the type of sound of claim 1, wherein the hypothetical test comprises a modified log-likelihood ratio test being applied to the plurality of audio snippets.

10. The method for detecting the type of sound of claim 9, wherein using at least the greater weighted one or more hypothetical values to determine whether at least one audio snippet includes the type of sound comprises:
comparing a summation of at least the greater weighted one or more hypothetical values to a predefined threshold value to determine whether at least one audio snippet includes the type of sound.

11. The method for detecting the type of sound of claim 10, wherein weighting the one or more hypothetical values greater than the one or more other hypothetical values comprises:
maximizing the summation of at least the greater weighted one or more hypothetical values by setting a value of a weighting variable.

12. The method for detecting the type of sound of claim 10, wherein weighting the one or more hypothetical values greater than the one or more other hypothetical values comprises:
setting a value of a weighting variable for each hypothetical value at least partially based on which hypothetical values are the greatest in magnitude.

13. The method for detecting the type of sound of claim 1, wherein performing the hypothetical test using the sampled plurality of audio snippets further comprises:
calculating a hypothetical value for each audio snippet of the plurality of audio snippets using a first probability model and a second probability model, wherein:
the first probability model indicates a first probability an audio snippet of the plurality of audio snippets includes the type of sound; and
the second probability model indicates a second probability the audio snippet of the plurality of audio snippets does not include the type of sound.

14. A computer program product residing on a non-transitory processor-readable medium for detecting a type of sound, the computer program product comprising computer-readable instructions configured to cause a computer system to:
sample a plurality of audio snippets;
perform a hypothetical test using the sampled plurality of audio snippets, the hypothetical test comprising:
weight one or more hypothetical values greater than one or more other hypothetical values, wherein each hypothetical value corresponds to an audio snippet of the plurality of audio snippets; and
use at least the greater weighted one or more hypothetical values to determine whether at least one audio snippet of the plurality of audio snippets comprises the type of sound.

15. The computer program product for detecting the type of sound of claim 14, wherein the computer-readable instructions configured to cause the computer system to sample the plurality of audio snippets further comprises additional computer-readable instructions configured to cause the computer system to:
cause at least a period of time to elapse between consecutive audio snippets of the plurality of audio snippets during which audio is not sampled.

16. The computer program product for detecting the type of sound of claim 15, wherein the period of time elapsing between when consecutive audio snippets of the plurality of audio snippets are captured is at least as long in time as one of the plurality of audio snippets.

17. The computer program product for detecting the type of sound of claim 14, wherein the type of sound is speech.

18. The computer program product for detecting the type of sound of claim 14, wherein one or more audio snippets of the plurality of audio snippets do not contain the type of sound.

19. The computer program product for detecting the type of sound of claim 14, wherein each audio snippet of the plurality of audio snippets is equal to or less than 200 ms in length.

20. The computer program product for detecting the type of sound of claim 14, wherein the computer system comprises a mobile device that is not being used for a voice call.

21. The computer program product for detecting the type of sound of claim 14, wherein the computer-readable instructions further comprise additional computer-readable instructions configured to cause the computer system to:
output an indication of the type of sound being present in response to determining at least one audio snippet of the plurality of audio snippets comprises the type of sound.

22. The computer program product for detecting the type of sound of claim 14, wherein the hypothetical test comprises a modified log-likelihood ratio test being applied to the plurality of audio snippets.

23. The computer program product for detecting the type of sound of claim 22, wherein the computer-readable instructions configured to cause the computer system to use at least the greater weighted one or more hypothetical values to determine whether at least one audio snippet includes the type of sound further comprises additional computer-readable instructions configured to cause the computer system to:
compare a summation of at least the greater weighted one or more hypothetical values to a predefined threshold value to determine whether at least one audio snippet includes the type of sound.

24. The computer program product for detecting the type of sound of claim 23, wherein the computer-readable instructions configured to cause the computer system to weigh the one or more hypothetical values greater than the one or more other hypothetical values further comprises additional computer-readable instructions configured to cause the computer system to:
maximize the summation of at least the greater weighted one or more hypothetical values by setting a value of a weighting variable.

25. The computer program product for detecting the type of sound of claim 23, wherein the computer-readable instructions configured to cause the computer system to weigh the one or more hypothetical values greater than the one or more other hypothetical values further comprises additional computer-readable instructions configured to cause the computer system to:
set a value of a weighting variable for each hypothetical value at least partially based on which hypothetical values are the greatest in magnitude.

26. The computer program product for detecting the type of sound of claim 14, wherein the computer-readable instructions configured to cause the computer system to perform the hypothetical test using the sampled plurality of audio snippets further comprises additional computer-readable instructions configured to cause the computer system to:
calculate a hypothetical value for each audio snippet of the plurality of audio snippets using a first probability model and a second probability model, wherein:
the first probability model indicates a first probability an audio snippet of the plurality of audio snippets includes the type of sound; and
the second probability model indicates a second probability the audio snippet of the plurality of audio snippets does not include the type of sound.

27. A mobile device, comprising:
a microphone;
a processor; and
a memory communicatively coupled with and readable by the processor and having stored therein processor-readable instructions which, when executed by the processor, cause the processor to:
sample a plurality of audio snippets from the microphone;
perform a hypothetical test using the sampled plurality of audio snippets, the hypothetical test comprising:
weight one or more hypothetical values greater than one or more other hypothetical values, wherein each hypothetical value corresponds to an audio snippet of the plurality of audio snippets; and
use at least the greater weighted one or more hypothetical values to determine whether at least one audio snippet of the plurality of audio snippets comprises a type of sound.

28. The mobile device of claim 27, wherein the processor-readable instructions configured to cause the processor to sample the plurality of audio snippets comprises additional processor-readable instructions that cause at least a period of time to elapse between consecutive audio snippets of the plurality of audio snippets during which audio is not sampled.

29. The mobile device of claim 28, wherein the period of time elapsing between when consecutive audio snippets of the plurality of audio snippets are captured is at least as long in time as one of the plurality of audio snippets.

30. The mobile device of claim 27, wherein the type of sound is speech.

31. The mobile device of claim 27, wherein one or more audio snippets of the plurality of audio snippets do not contain the type of sound.

32. The mobile device of claim 27, wherein each audio snippet of the plurality of audio snippets is equal to or less than 200 ms in length.

33. The mobile device of claim 27, wherein the processor-readable instructions are not performed during voice calls using the mobile device.

34. The mobile device of claim 27, wherein the processor-readable instructions further comprise additional processor-readable instructions configured to cause the processor to:
output an indication of the type of sound being present in response to determining at least one audio snippet of the plurality of audio snippets comprises the type of sound.

35. The mobile device of claim 27, wherein the hypothetical test comprises a modified log-likelihood ratio test being applied to the plurality of audio snippets.

36. The mobile device of claim 35, wherein the processor-readable instructions configured to cause the processor to use at least the greater weighted one or more hypothetical values to determine whether at least one audio snippet includes the type of sound further comprises additional processor-readable instructions configured to cause the processor to:
compare a summation of at least the greater weighted one or more hypothetical values to a predefined threshold value to determine whether at least one audio snippet includes the type of sound.

37. The mobile device of claim 36, wherein the processor-readable instructions configured to cause the processor to weigh the one or more hypothetical values greater than the one or more other hypothetical values further comprises additional processor-readable instructions configured to cause the processor to:
maximize the summation of at least the greater weighted one or more hypothetical values by setting a value of a weighting variable.

38. The mobile device of claim 36, wherein the processor-readable instructions configured to cause the processor to weigh the one or more hypothetical values greater than the one or more other hypothetical values further comprises additional processor-readable instructions configured to cause the processor to:
set a value of a weighting variable for each hypothetical value at least partially based on which hypothetical values are the greatest in magnitude.

39. The mobile device of claim 27, wherein the processor-readable instructions configured to cause the processor to perform the hypothetical test using the sampled plurality of audio snippets further comprises additional processor-readable instructions configured to cause the processor to:
calculate a hypothetical value for each audio snippet of the plurality of audio snippets using a first probability model and a second probability model, wherein:
the first probability model indicates a first probability an audio snippet of the plurality of audio snippets includes the type of sound; and
the second probability model indicates a second probability the audio snippet of the plurality of audio snippets does not include the type of sound.

40. An apparatus for detecting a type of sound, the apparatus comprising:
means for sampling a plurality of audio snippets;
means for performing a hypothetical test using the sampled plurality of audio snippets, the means for performing the hypothetical test comprising:
means for weighting one or more hypothetical values greater than one or more other hypothetical values, wherein each hypothetical value corresponds to an audio snippet of the plurality of audio snippets; and
means for using at least the greater weighted one or more hypothetical values to determine whether at least one audio snippet of the plurality of audio snippets comprises the type of sound.

41. The apparatus for detecting the type of sound of claim 40, wherein the means for sampling the plurality of audio snippets is configured such that at least a period of time elapses between consecutive audio snippets of the plurality of audio snippets during which audio is not sampled.

42. The apparatus for detecting the type of sound of claim 41, wherein the period of time elapsing between when consecutive audio snippets of the plurality of audio snippets are captured is at least as long in time as one of the plurality of audio snippets.

43. The apparatus for detecting the type of sound of claim 40, wherein the type of sound is speech.

44. The apparatus for detecting the type of sound of claim 40, wherein one or more audio snippets of the plurality of audio snippets do not contain the type of sound.

45. The apparatus for detecting the type of sound of claim 40, wherein each audio snippet of the plurality of audio snippets is equal to or less than 200 ms in length.

46. The apparatus for detecting the type of sound of claim 40, wherein the apparatus is part of a mobile device.

47. The apparatus for detecting the type of sound of claim 40, further comprising:
means for outputting an indication of the type of sound being present in response to determining at least one audio snippet of the plurality of audio snippets comprises the type of sound.

48. The apparatus for detecting the type of sound of claim 40, wherein the hypothetical test comprises a modified log-likelihood ratio test being applied to the plurality of audio snippets.

49. The apparatus for detecting the type of sound of claim 48, wherein the means for using at least the greater weighted one or more hypothetical values to determine whether at least one audio snippet includes the type of sound comprises:
means for comparing a summation of at least the greater weighted one or more hypothetical values to a predefined threshold value to determine whether at least one audio snippet includes the type of sound.

50. The apparatus for detecting the type of sound of claim 49, wherein the means for weighting the one or more hypothetical values greater than the one or more other hypothetical values comprises:
means for maximizing the summation of at least the greater weighted one or more hypothetical values by setting a value of a weighting variable.

51. The apparatus for detecting the type of sound of claim 49, wherein the means for weighting the one or more hypothetical values greater than the one or more other hypothetical values comprises:
means for setting a value of a weighting variable for each hypothetical value at least partially based on which hypothetical values are the greatest in magnitude.

52. The apparatus for detecting the type of sound of claim 40, wherein the means for performing the hypothetical test using the sampled plurality of audio snippets further comprises:
means for calculating a hypothetical value for each audio snippet of the plurality of audio snippets using a first probability model and a second probability model, wherein:
the first probability model indicates a first probability an audio snippet of the plurality of audio snippets includes the type of sound; and
the second probability model indicates a second probability the audio snippet of the plurality of audio snippets does not include the type of sound.
